(19) United States
(12) Patent Application Publication
(10) Pub. No.: US 2011/0129322 A1
(43) Pub. Date: Jun. 2, 2011

(54) WAFER CONVEYING SYSTEM

(76) Inventor: Chih-hao HUANG, Hsinchu City (TW)

(21) Appl. No.: 12/785,529

(22) Filed: May 24, 2010

(30) Foreign Application Priority Data
Nov. 30, 2009 (TW) 098140801

(51) Int. Cl. B65G 35/00

(52) U.S. Cl. 414/676

(57) ABSTRACT

A wafer conveying system includes a first conveying unit, a second conveying unit, a floating type conveying unit set between the first conveying unit and the second conveying unit for transferring wafers from the first conveying unit to the second conveying unit, two guide devices arranged at the two opposite lateral sides of the floating type conveying unit for guiding every transferring wafer from the first conveying unit through the floating type conveying unit to a predetermined location or its nearby area at the second conveying unit, and a test unit installed in the second conveying unit for testing the same area of every wafer been transferred to the second conveying unit.

### FIELD OF THE INVENTION

The present invention is related to wafer transferring technology and more specifically, to a wafer conveying system, which uses a floating conveying unit to transfer wafers from a first conveying unit to a predetermined location or its nearby area at a second conveying unit for examination.

### BACKGROUND

During wafer fabrication or examination, it is necessary to transfer wafers from one place to another place. Because wafers are light, thin and fragile members, an accidental impact during transfer may cause damage to the wafer structure, for example, breaking, deficit angle or invisible crack, resulting in lowering of the yield rate.

FIG. 1 is a top view of a wafer conveying system according to the prior art. As illustrated, the wafer conveying system 10 comprises a first conveying belt 11 and a second conveying belt 13. The first conveying belt 11 and the second conveying belt 13 are arranged in a line in proximity to each other so that wafers 12 are transferable from the first conveying belt 11 to the second conveying belt 13. The first conveying belt 11 has a width W1 greater than the width W2 of the second conveying belt 13. Further, a test unit 15 is installed in the second conveying belt 13 for examining every wafer 12 been transferred from the first conveying belt 11 to the second conveying belt 13.

During transfer of wafers 12, the operator may place every wafer 12 on the mid point of the first conveying belt 11 or a predetermined area at the first conveying belt 11. When one wafer 12 is being transferred by the first conveying belt 11 to the second conveying belt 13, the wafer 12 may be placed on the mid point of the second conveying belt 13 or a predetermined area at the second conveying belt 13 so that the test unit 15 can examine one same area of every transferred wafer 12.

However, because the first conveying belt 11 and the second conveying belt 13 are driven to move mechanically, vibration tends to occur during transfer of wafers 12, causing transferring wafers 12 to displace. Thus, every transferring wafer 12 may be not kept on the mid point of the first conveying belt 11 or the second conveying belt 13 or the predetermined area at the first conveying belt 11 or the second conveying belt 13, causing the test unit 14 unable to examine one same area of every transferred wafer 12.

### SUMMARY OF THE PRESENT INVENTION

It is, therefore, the main object of the present invention to provide a wafer conveying system, which uses a floating type conveying unit to transfer wafers from a first conveying unit to a second conveying unit without friction, avoiding heavy impact during guiding and transferring wafer and keeping transferring wafers intact.

It is another object of the present invention to provide a wafer conveying system, which has a guide device provided at each of the two opposite lateral sides of the floating type conveying unit for guiding every transferring wafer to a predetermined location at the second conveying unit or its nearby area so that the test unit at the second conveying unit can examine the same area of every transferred wafer, facilitating improvement of test accuracy.

It is still another object of the present invention to provide a wafer conveying system, which minimizes friction resistance between the guide devices and the wafer that is being transferred from the first conveying unit through the floating type conveying unit to the second conveying unit, thereby reducing impact and effectively prolonging the lifespan of the guide devices.

It is still another object of the present invention to provide a wafer conveying system, which has the width of the output end of floating type conveying unit made approximately equal to the width of the wafers to be transferred. Thus, as a wafer is being transferred through the floating type conveying unit, it will be guided to the correct position.

It is still another object of the present invention to provide a wafer conveying system, which has the width of the input end of the floating type conveying unit made approximately equal to the width of the first conveying unit, facilitating transfer of wafers from the first conveying unit to the floating type conveying unit.

It is still another object of the present invention to provide a wafer conveying system, which has the width of the output end of the floating type conveying unit made approximately equal to the width of the second conveying unit so that every wafer will be placed on a predetermined location or its nearby area at the second conveying unit when passed through the floating type conveying unit.

To achieve these and other objects of the present invention, a wafer conveying system comprises a first conveying unit, a second conveying unit, a floating type conveying unit set between the first conveying unit and the second conveying unit for transferring wafers from the first conveying unit to the second conveying unit, at least one guide device arranged at least one of the two opposite lateral sides of the floating type conveying unit for guiding every transferring wafer from the first conveying unit through the floating type conveying unit to a predetermined location or its nearby area at the second conveying unit, and a test unit installed in the second conveying unit for testing the same area of every wafer been transferred to the second conveying unit.

### BRIEF DESCRIPTION OF THE DRAWINGS

FIG. 1 is a schematic top view of a wafer conveying system according to the prior art.

FIG. 2 is a perspective view of a wafer conveying system in accordance with the present invention.

FIG. 2A is a schematic sectional view of a part of the wafer conveying system in accordance with the present invention, showing the structure of the floating type conveying unit.

FIG. 2B is a schematic side plain view of the wafer conveying system in accordance with the present invention.

FIG. 2C is a top view of the wafer conveying system in accordance with the present invention.

FIGS. 3A˜3D illustrate the wafer-transferring operation flow of the wafer conveying system in accordance with the present invention.

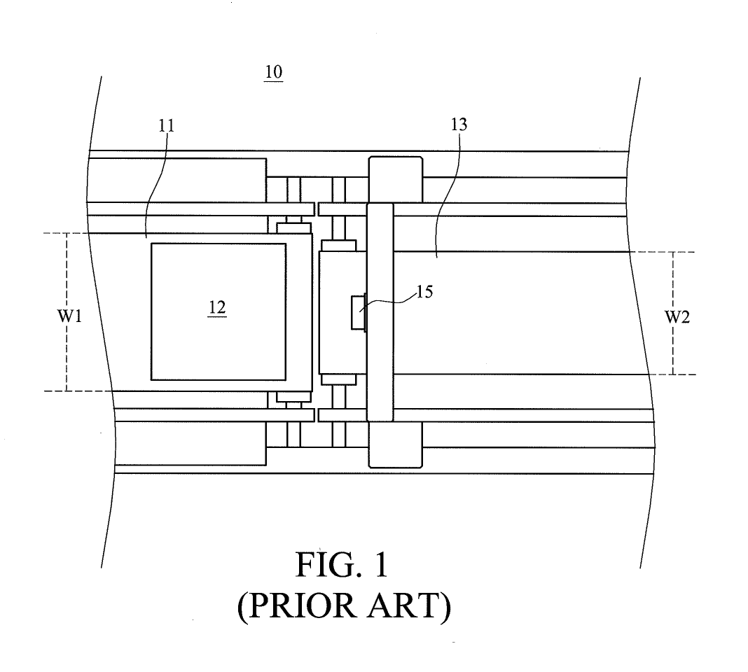

### DETAILED DESCRIPTION OF THE PREFERRED EMBODIMENTS

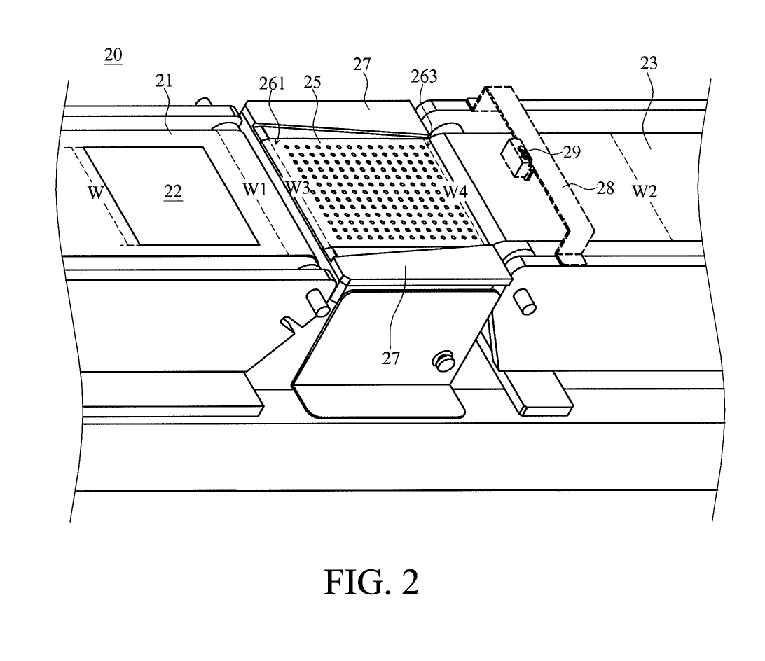

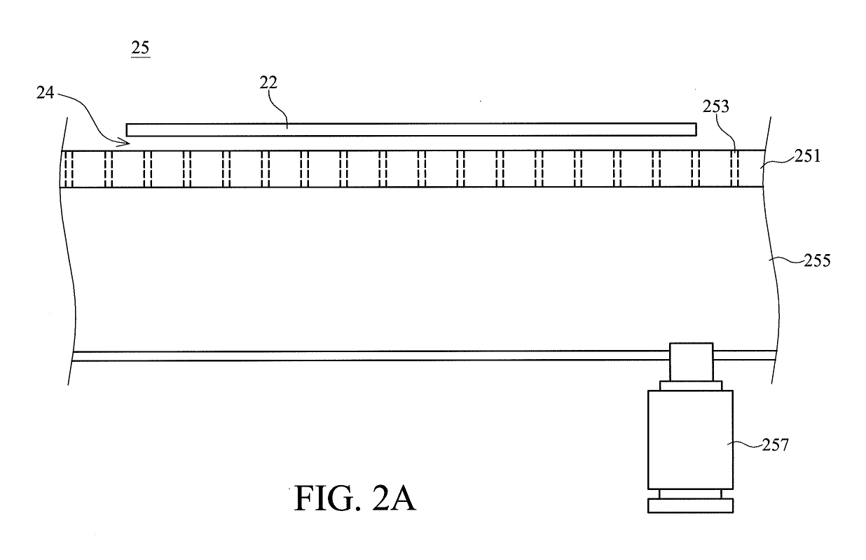

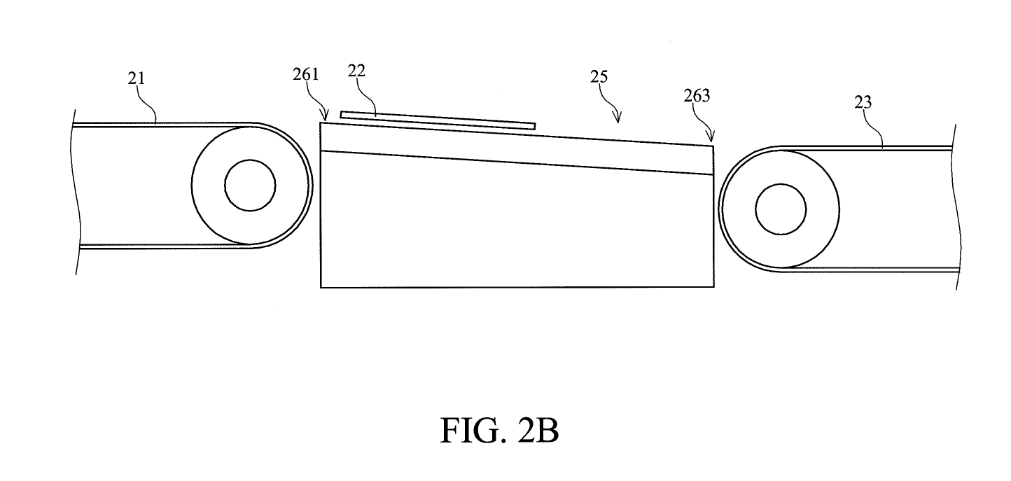

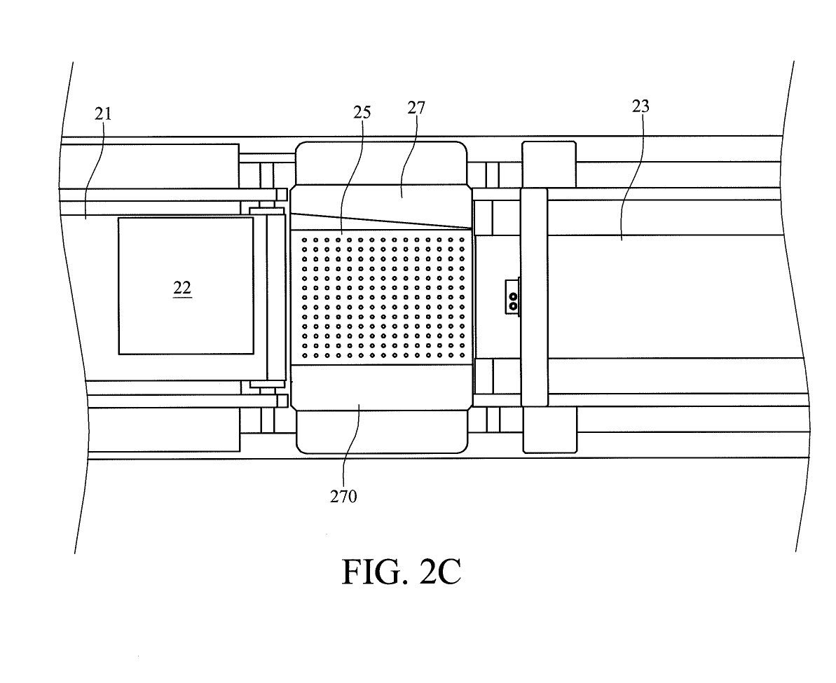

Referring to FIG. 2, there is shown a perspective view of a wafer conveying system in accordance with the present invention. A wafer conveying system 20 comprises a first conveying unit 21, a second conveying unit 23 and a floating type conveying unit 25. The floating type conveying unit 25 is set between the first conveying unit 21 and the second conveying unit 23 for receiving a wafer 22 from the first conveying unit 21 and transferring the wafer 22 to the second conveying unit 23.

The floating type conveying unit 25 does not touch the wafer 22 when transferring the wafer 22 from the first conveying unit 21 to the second conveying unit 23, i.e., the wafer 22 is floating above the surface of the floating type conveying unit 25 during transfer. According to this embodiment, the floating type conveying unit 25 is an air float type design, comprising a flat panel 251, an air chamber 255 and an air supply source 257. The air chamber 255 is defined beneath the flat panel 251 and connected with the air supply source 257. The flat panel 251 has a plurality of through holes 253 cut through the top and bottom sides thereof so that the air produced by the air supply source 257 is delivered to the air chamber 255 and forced out of the floating type conveying unit 25 through the through holes 253 of the flat panel 251 to support the wafer 22 above the flat panel 251 and to form an air film 24 between the flat panel 251 and the wafer 22, as shown in FIG. 2A. Alternatively, the floating type conveying unit 25 can be a vibration type design for making the wafer 22 to float above the flat panel 251.

The first conveying unit 21 of the wafer conveying system 20 has a width W1 greater than the width W2 of the second conveying unit 23. In order to facilitate transfer and guidance of one wafer 22 from the first conveying unit 21 to the second conveying unit 23 through the floating type conveying unit 25, at least one guide device 27 is provided. According to this embodiment, two guide devices 27 are arranged at two opposite lateral sides of the floating type conveying unit 25, defining therebetween an input end 261 and an output end 263 on the floating type conveying unit 25, wherein the width W3 of the input end 261 is greater than the width W4 of the output end 263 and, the width of the floating type conveying unit 25 or the width between the two guide devices 27 reduces gradually in direction from the input end 261 toward the output end 263 for correcting the position of the wafer 22 that is being transferred through the floating type conveying unit 25.

The input end 261 of the floating type conveying unit 25 is connected to the first conveying unit 21 for enabling a wafer 22 to be transferred by the first conveying nit 21 into the floating type conveying unit 25 through the input end 261. Further, in order to improve the convenience in using the system, the width W3 of the input end 261 can be approximately equal to the width W1 of the first conveying unit 21 of the wafer conveying system 20, facilitating transfer of one wafer 22 from the first conveying nit 21 to the floating type conveying unit 25.

Furthermore, the output end 263 of the floating type conveying unit 25 is connected to the second conveying unit 23 for enabling a wafer 22 to be transferred by the floating type conveying unit 25 to the second conveying unit 23. The width W4 of the output end 263 can be approximately equal to the width W2 of the second conveying unit 23. Moreover, the width W4 and the width W2 are approximately equal to the width W of every wafer 22 to be transferred so that every wafer 22 that is being transferred through the output end 263 and the second conveying unit 23 is kept in the correct direction.

In one preferred embodiment of the present invention, the elevation of the first conveying unit 21 is slightly higher than the second conveying unit 23, and the floating type conveying unit 25 slopes in one direction, for example, to keep the input end 261 relatively higher than the output end 263 so that every wafer 22 under transfer can be forced to move from the input end 261 toward the output end 263 subject to the effect of gravity, as shown in FIG. 2B.

By means of the guide devices 27 and the floating type conveying unit 25, the invention guides the position and path of every wafer 22 under transfer, enabling every wafer 22 to be transferred from the first conveying unit 21 to the second conveying unit 23 so that every wafer 22 that passes through the floating type conveying unit 25 and the guide devices 27 will be guided to a predetermined location or its nearby area at the second conveying unit 23.

In one embodiment of the present invention, a test unit 29 is provided above the second conveying unit 23 to examine the same area of every transferred wafer 22 that falls to the predetermined location or its nearby area at the second conveying unit 23 due to the guide device 27, facilitating improvement of the test accuracy. For example, a bracket 28 is mounted on the top side of the second conveying unit 23 to hold the test unit 29 above the second conveying unit 23, enabling the test unit 29 to examine every wafer 22 placed on the second conveying unit 23.

When the guide devices 27 guide one wafer 22 through the input end 261 and the output end 263 on the floating type conveying unit 25, the transferring wafer 22 may impact the guide devices 27. Because a wafer 22 is a thin and fragile member, its structure may be damaged upon an impact. For example, the wafers 22 to be transferred can be solar cell silicon wafers. A regular solar cell silicon wafer has a quadrilateral configuration. When one solar cell silicon wafer collides with the guide devices 27, a corner wear of the solar cell silicon wafer may occur, resulting in a low yield rate. Further, the guide devices 27 may wear quickly with use, shortening guide device lifespan.

According to the preferred embodiment of the present invention, the floating type conveying unit 25 is adapted for transferring a wafer 22 from the first conveying unit 21 to the second conveying unit 23, and the two guide devices 27 are arranged at the two opposite lateral sides of the floating type conveying unit 25. Because an air film 24 exists between the flat panel 251 of the floating type conveying unit 25 and the transferring wafer 22, as shown in FIG. 2A, the transferring wafer 22 does not touch the flat panel 251 directly, and therefore there is almost no any friction force between the transferring wafer 22 and the floating type conveying unit 25. Thus, if the transferring wafer 22 collides with the guide devices 27 and is caused to change its moving direction during transfer, the impact force between the transferring wafer 22 and the guide devices 27 will be minimized, avoiding the chance of structural damage of the transferring wafer 22 and helping prolonging the lifespan of the guide devices 27. Because there is almost no any friction force between the transferring wafer 22 and the floating type conveying unit 25, applying a small external force to the transferring wafer 22 can cause the transferring wafer 22 to change its moving direction, thereby reducing the impact force upon contact between the transferring wafer 22 and the guide devices 27.

To facilitate explanation of the spirit of the present invention, two guide devices 27 are used in the preferred embodiment. However, this arrangement is not a limitation. In actual practice, the wafer conveying system 20 can be equipped with one single guide device 27, and the guide device 27 can be arranged at one lateral side of the floating type conveying unit 25 that has an upright sidewall 270 at the opposite lateral side. By means of the guide device 27 and the sidewall 270, every wafer 22 can be accurately transferred from the first conveying unit 21 to the predetermined location or its nearby area at the second conveying unit 23, as shown in FIG. 2C.

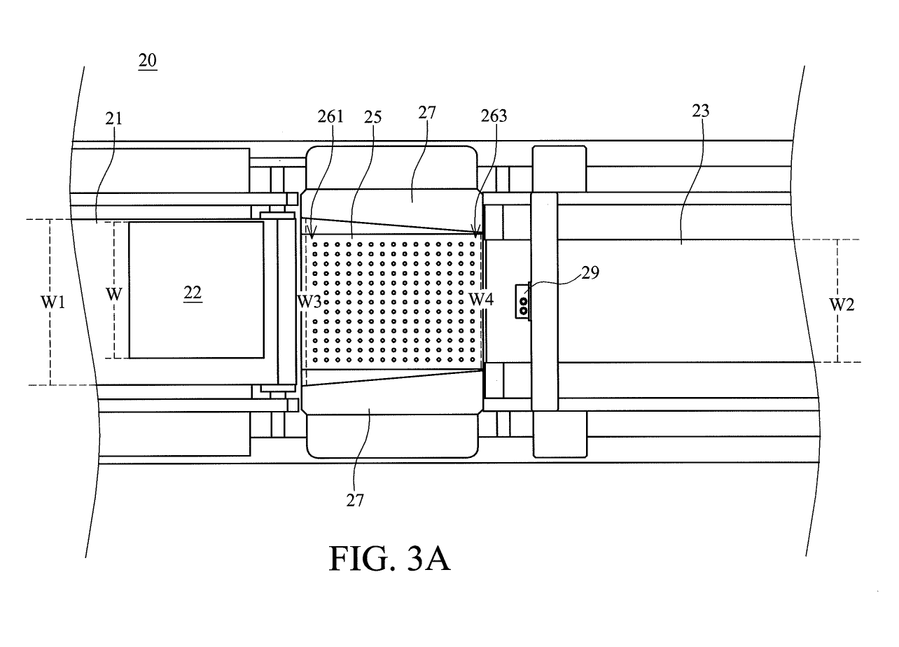

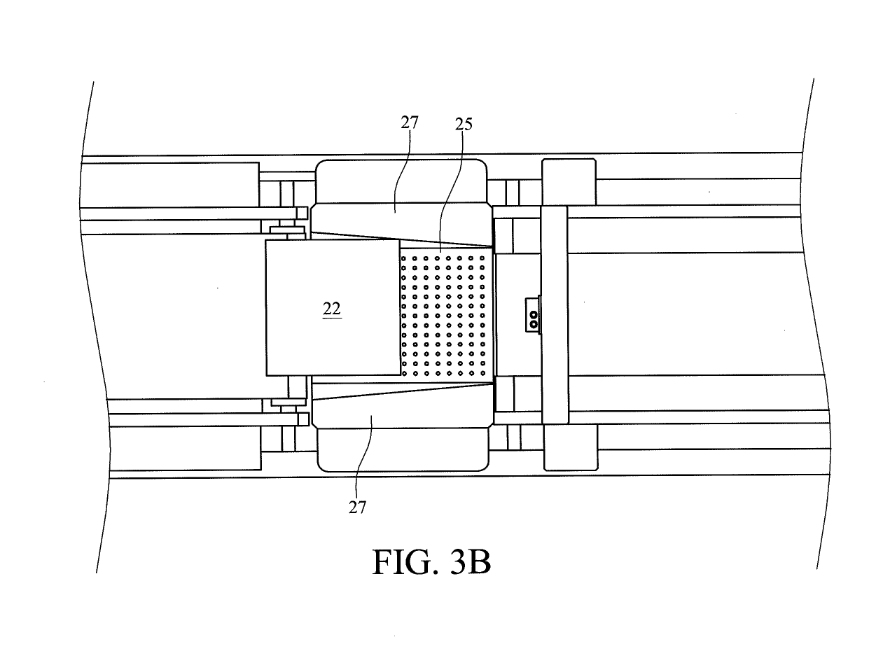

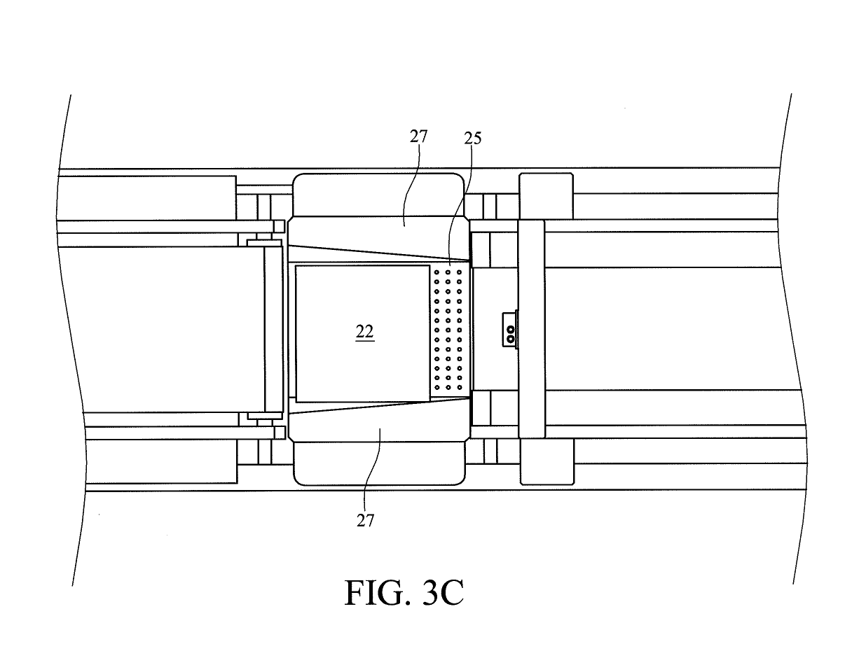

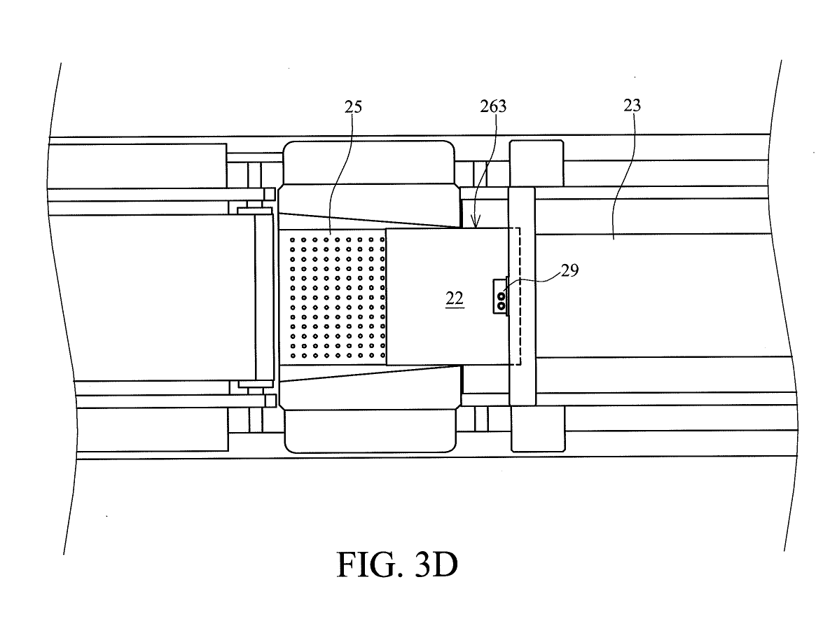

Referring to FIG. 3A to FIG. 3D, there are shown the wafer-transferring operation flow of the wafer conveying system in accordance with the present invention. As illustrated, the wafer conveying system 20 comprises a first conveying unit 21, a second conveying unit 23, a floating type conveying unit 25 connected between the first conveying unit 21 and the second conveying unit 23 and at least one guide device 27 provided at least one of the two opposite lateral sides of the floating type conveying unit 25.

When transferring wafers 22, every wafer 22 is guided to or placed on the first conveying unit 21 and then transferred by the first conveying unit 21 to the floating type conveying unit 25, as shown in FIG. 3A. Because the width W1 of the first conveying unit 21 is approximately equal to the width W3 of the floating type conveying unit 25, for example, W1 is smaller or equal to W3, every wafer 22 is smoothly transferred by the first conveying unit 21 to the floating type conveying unit 25.

Normally, the position of every wafer 22 that is guided to or placed on the first conveying unit 21 is not all the same. When one wafer 22 is guided to or placed on the first conveying unit 21, it may be deviated leftward or rightward. When one leftward-deviated or rightward-deviated wafer 22 is being transferred through the floating type conveying unit 25, it will collide with the guide devices 27. Further, when one wafer 22 is being transferred from the first conveying unit 21 to the floating type conveying unit 25, the wafer 22 will keep moving toward the second conveying unit 23 subject to its inertia effect, and therefore the wafer 22 can be transferred through the floating type conveying unit 25 to the second conveying unit 23. In one embodiment of the present invention, the floating type conveying unit 25 slopes in one direction, for example, the input end 261 is relatively higher than the output end 263 so that the transferring wafer 22 can be transferred through the floating type conveying unit 25 to the second conveying unit 23 subject to the effect of gravity.

When one leftward-deviated or rightward-deviated wafer 22 is being transferred through the floating type conveying unit 25, it will collide with one guide device 27 and forced to move obliquely forwards subject to the effect of inertia or gravity. For example, when one leftward-deviated wafer 22 is moving forwards, it will collide with the left-sided guide device 27, as shown in FIG. 3B, and will then be forced by the left-sided guide device 27 to move toward the right-sided guide device 27; when the wafer 22 touches the right-sided guide device 27, it will be forced by the right-sided guide device 27 to move toward the left-sided guide device 27, as shown in FIG. 3C.

In actual application, when one wafer 22 enters the floating type conveying unit 25, it may touch the left-sided guide device 27 or the right-sided guide device 27 at first. Further, the number of times in which every transferring wafer 22 touches the guide devices 27 is not constantly the same. One transferring wafer 22 may pass through the floating type conveying unit 25 directly without touch the guide devices 27, or may touch the guide devices 27 several times during its movement through the floating type conveying unit 25. Because the transferring wafer 22 is floating on the floating type conveying unit 25, there is almost zero friction resistance between the transferring wafer 22 and the floating type conveying unit 25. Therefore, even the transferring wafer 22 touches one guide device 27, the impact force between the transferring wafer 22 and the guide device 27 is minimized, facilitating prolongation of the lifespan of the guide devices 27 and avoiding damage to the structure of the wafer 22 under transfer.

No matter how many times one transferring wafer 22 touched the guide devices 27, the guide devices 27 can correct the position of the transferring wafer 22. The distance between the two guide devices 27 reduces gradually in one direction. For example, the width W3 of the input end 261 of the floating type conveying unit 25 is greater than the width W4 of the output end 263 of the floating type conveying unit 25, and the distance between the two guide devices 27 reduces gradually in one direction from W3 (the input end 261) toward width W4 (the output end 263), facilitating guidance of wafers 22.

Further, the width W4 of the output end 263 of the floating type conveying unit 25 is approximately equal to the width W2 of the second conveying unit 23 of the wafer conveying system 20. For example, W4 can be smaller than or equal to W2, so that one wafer 22 can be transferred from the floating type conveying unit 25 to the second conveying unit 23, as shown in FIG. 3D. Because the width W4 of the output end 263 of the floating type conveying unit 25 is approximately equal to the width W2 of the second conveying unit 23 of the wafer conveying system 20, one wafer 22 that is transferred from the floating type conveying unit 25 to the second conveying unit 23 will be guided to a predetermined location or its nearby area at the second conveying unit 23. Thus, a test unit 29 can be provided above the second conveying unit 23 to examine the same area of every wafer 22 that be placed on the predetermined location or its nearby area at the second conveying unit 23, facilitating improvement of the test accuracy.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wafer conveying system, comprising:
a first conveying unit;
a second conveying unit;
a floating type conveying unit set between said first conveying unit and said second conveying unit for transferring wafers from said first conveying unit to said second conveying unit; and
at least one guide device arranged at least one of two opposite lateral sides of said floating type conveying unit for guiding movement of every wafer being transferring from said first conveying unit through said floating type conveying unit to said second conveying unit.

2. The wafer conveying system as claimed in claim 1, further comprising a test unit mounted in said second conveying unit and adapted to examine every wafer been transferred to said second conveying unit.

3. The wafer conveying system as claimed in claim 1, wherein said floating type conveying unit is selected from a group consisting of an air float type design and a vibration type design.

4. The wafer conveying system as claimed in claim 1, wherein the number of said at least one guide device is 2, and the two guide devices are respectively arranged at the two opposite lateral sides of said floating type conveying unit.

5. The wafer conveying system as claimed in claim 1, wherein said first conveying unit has a width greater than the width of said second conveying unit.

6. The wafer conveying system as claimed in claim 1, wherein the wafers to be transferred from said first conveying unit through said floating type conveying unit to said second conveying unit are solar wafers.

7. The wafer conveying system as claimed in claim 1, wherein said floating type conveying unit has an input end connected to said first conveying unit and an output end connected to said second conveying unit.

8. The wafer conveying system as claimed in claim 7, wherein said input end of said floating type conveying unit is higher than said output end.

9. The wafer conveying system as claimed in claim 8, wherein said first conveying unit has an elevation higher than said second conveying unit.

10. The wafer conveying system as claimed in claim 7, wherein said input end has a width greater than the width of said output end.

11. The wafer conveying system as claimed in claim 7, wherein said floating type conveying unit has a width reduces gradually in direction from said input end toward said output end.

12. The wafer conveying system as claimed in claim 7, wherein said input end has a width approximately equal to the width of said first conveying unit.

13. The wafer conveying system as claimed in claim 7, wherein said output end has a width approximately equal to the width of said second conveying unit.

14. The wafer conveying system as claimed in claim 7, wherein said output end has a width approximately equal to the width of the wafers to be transferred.

15. The wafer conveying system as claimed in claim 1, wherein said floating type conveying unit comprises a flat panel, said flat panel having a plurality of through holes cut through top and bottom sides thereof, an air chamber defined beneath said flat panel in air communication with said through holes and an air supply source controllable to supply a gas to said air chamber.

16. The wafer conveying system as claimed in claim 1, wherein the number of said at least one guide device is 1, and the guide device is located on one lateral side of said floating type conveying unit; said floating type conveying unit has an upright sidewall disposed at one lateral side thereof opposite to said guide device.
